(19) United States
(12) Patent Application Publication
(10) Pub. No.: US 2017/0325159 A1
(43) Pub. Date: Nov. 9, 2017

(54) EXTENSION OF ACCESS NETWORK DISCOVERY AND SELECTION FUNCTION (ANDSF) TO SUPPORT AD-HOC NETWORK SELECTION

(71) Applicant: Nokia Technologies Oy, Espoo (FI)

(72) Inventors: Jarkko KNECKT, Espoo (FI); Mika KASSLIN, Espoo (FI); Janne MARIN, Espoo (FI); Enrico-Henrik RANTALA, Berkeley, CA (US); Olli ALANEN, Vantaa (FI)

(21) Appl. No.: 15/533,763

(22) PCT Filed: Dec. 11, 2014
(86) PCT No.: PCT/US2014/069830

§ 371 Date: Jun. 7, 2017

(51) Int. Cl. H04W 48/18; H04W 8/18; H04W 48/14; H04W 76/02

(52) U.S. Cl. CPC H04W 48/18; H04W 76/023; H04W 8/18; H04W 48/14

(57) ABSTRACT

An extension to ANDSF management object as defined in TS 23.312 is provided to support adhoc network connection establishment like WF-Fi direct or WLAN direct. In some example embodiments there is provided a method. The method may include receiving, at a user equipment, a network selection policy, wherein the network selection policy indicates whether the user equipment is allowed to or inhibited from operating in accordance with a local service network; allowing, at the user equipment when the received network selection policy indicates an allowance, transmission via the local service network; and inhibiting, at the user equipment when the received network selection policy indicates an inhibition, transmission via the local service network. Related systems, methods, and articles of manufacture are also disclosed.

### FIELD

The subject matter described herein relates to wireless communications.

### BACKGROUND

Network discovery, selection, and provisioning technologies facilitate and can automate the discovery/selection of networks and allow service providers/network operators to handle interoperability between different network technologies. To that end, standards may be used to facilitate network discovery, selection, and provisioning. An example of a network discovery, selection, and provisioning standard is the 3rd Generation Partnership Project, Technical Specification Group Core network and Terminals, Access Network Discovery and Selection Function (ANDSF) Management Object (Release 9), 3GPP TS 24.312 V.9.0.0 (2009 December), as well as subsequent revisions, additions, and the like thereto (referred to herein as the “ANDSF standard”).

### SUMMARY

In some example embodiments, there is provided a method. The method may include receiving, at a user equipment, a network selection policy, wherein the network selection policy indicates whether the user equipment is allowed to or inhibited from operating in accordance with a local service network; allowing, at the user equipment when the received network selection policy indicates an allowance, transmission via the local service network; and inhibiting, at the user equipment when the received network selection policy indicates an inhibition, transmission via the local service network.

In some variations, one or more of the features disclosed herein including the following features can optionally be included in any feasible combination. The network selection policy may be received from at least one of a cellular network or a wireless local area network controller. The network selection policy may be evaluated to determine whether transmission via the local service network is allowed to operate within a coverage area defined by the network selection policy. The evaluating may be triggered by at least one of signaling received from a network node or an event at the user equipment. The network selection policy may include at least one access network discovery and selection function policy. The at least one access network discovery and selection function policy may be sent by an access network discovery and selection function server as an access network discovery and selection function management object including information to control the local service network. The network selection policy may include at least one of a rule priority representative of a priority for a rule contained within the network selection policy, a validity area indicating an area over which the rule is to be enforced, a time of day indicating a time when the rule is to be enforced, and one or more parameters. The one or more parameters may define at least one of a type of access technology, an indication of whether the type of access technology is allowed, transmit power information, or channel information. The local service network may include a non-infrastructure wireless local area network providing at least one of a service or application among a plurality of user equipment coupled via the local service network. The local service network may include at least one of a Wi-Fi direct, Wi-Fi screencasting, an independent basic service set, or miracast.

The above-noted aspects and features may be implemented in systems, apparatuses, methods, and/or computer-readable media depending on the desired configuration. The details of one or more variations of the subject matter described herein are set forth in the accompanying drawings and the description below. Features and advantages of the subject matter described herein will be apparent from the description and drawings, and from the claims. In some exemplary embodiments, one of more variations may be made as well as described in the detailed description below and/or as described in the following features.

### DESCRIPTION OF DRAWINGS

In the drawings,

FIG. 1 depicts an example of network selection policy for non-infrastructure network control, in accordance with some example embodiments;

FIG. 2 depicts an example of a network in which network selection policy for non-infrastructure network control may be implemented, in accordance with some example embodiments;

FIG. 3 depicts a process for network selection policy for non-infrastructure network control, in accordance with some example embodiments; and

FIG. 4 an example of an apparatus, in accordance with some example embodiments.

Like labels are used to refer to the same or similar items in the drawings.

### DETAILED DESCRIPTION

As wireless local area network (WLAN) deployments increase, there may be a need to implement greater coordination between different types of wireless local area networks to enable the delivery of a better and a more consistent experience. In the case of Wi-Fi wireless local area networks, different types of Wi-Fi networks may be implemented, and these different types of Wi-Fi networks include infrastructure Wi-Fi networks, non-infrastructure Wi-Fi networks including Wi-Fi Direct™, Miracast (which refers to a peer-to-peer wireless screencasting provided via for example Wi-Fi Direct™), peer-to-peer Wi-Fi, Independent Basic Service Set (IBSS), and/or the like. The non-infrastructure Wi-Fi represents a local Wi-Fi network in the sense that it carries a local service, such as screencasting and/or the like, among local devices. In contrast, an infrastructure Wi-Fi serves a small cell and provides for example access to another network, such as the Internet or a cellular network.

3GPP and the Wi-Fi Alliance have defined information and methods with respect to when, where, and how devices can connect to alternative bearers, such as a WLAN infrastructure, and these information elements may take the form of management objects.

In the case of 3GPP, the ANDSF standard defines an Access Network Discovery and Selection Function (ANDSF) management object, which may include rules including parameters for offloading to a WLAN. The ANDSF rules (also referred to as policies) may provide a way for a mobile network operator to use policy-based steering of traffic between cellular access networks, such as Third Generation Partnership Project (3GPP) type access networks, and other types of networks, such as non-3GPP-type access networks (for example, wireless local area networks, such as Wi-Fi networks) and the like. The ADSDF rules/policies may include inter-system mobility policy, inter-system routing policy, and/or discovery information to enable a user equipment to perform network selection among infrastructure networks. In the case of the Wi-Fi Alliance, Passpoint may, like ANDSF, define a structure, information elements, and/or management object having rules, parameters, and the like for managing the offloading to/from a WLAN infrastructure, such as the alternative bearers of the Wi-Fi infrastructure network. But the management objects in ANSDSF, Passpoint, and the like are directed to serve infrastructure networks, rather than certain other types of WLAN/Wi-Fi networks, such as non-infrastructure Wi-Fi. Non-infrastructure Wi-Fi networks represents a type of Wi-Fi connection that may be configured as a point-to-point connection between two devices when needed (for example, as a local service network providing a point-to-point or peer-to-peer connection for a local service such as screencast and/or the like), rather than between a device and a Wi-Fi wireless access point serving a given infrastructure coverage area. For example, an infrastructure Wi-Fi network may serve a small cell and provide Internet access, while a non-infrastructure Wi-Fi network may represent peer-to-peer connections where local services/applications may be shared, accessed, and/or the like. Examples of these local service networks (or non-infrastructure) include Wi-Fi Direct, Wi-Fi IBSS, Wi-Fi screen casting with Miracast, and the like.

Wireless service providers (or operators) may have a need to control non-infrastructure WLAN networks to ensure that these non-infrastructure Wi-Fi networks do not cause unnecessary interference to other types of networks. For example, an infrastructure Wi-Fi network may provide a coverage area serving one or more devices in the coverage area. Within this coverage area, there may be, however, a non-infrastructure Wi-Fi network between peer user equipment causing interference to a Wi-Fi wireless access point serving the coverage area.

In some example embodiments, the subject matter disclosed herein may provide a mechanism to control the use of the non-infrastructure Wi-Fi networks in areas where infrastructure Wi-Fi networks are present.

In some example embodiments, one or more management objects may be augmented to provide information regarding a non-infrastructure WLAN.

In some example embodiments, one or more management objects are augmented to provide information regarding how user equipment can use non-infrastructure networks/WLAN, where the non-infrastructure networks/WLAN can be used, and/or when the non-infrastructure networks/WLAN can be used. The management object may thus allow service providers/operators to control the use of a non-infrastructure networks/WLAN.

In some example embodiments, a branch may be added to a management object. The augmented management object may control non-infrastructure networks, such as non-infrastructure WLAN including non-infrastructure Wi-Fi. In some example embodiments, the augmented management object may be configured in accordance with a standard, such as an ANDSF management object as defined by the ANDSF standard, although other management object structures and standards may be implemented as well including, for example, Hot Spot 2.0, PerProviderSubcription management object, and/or the like.

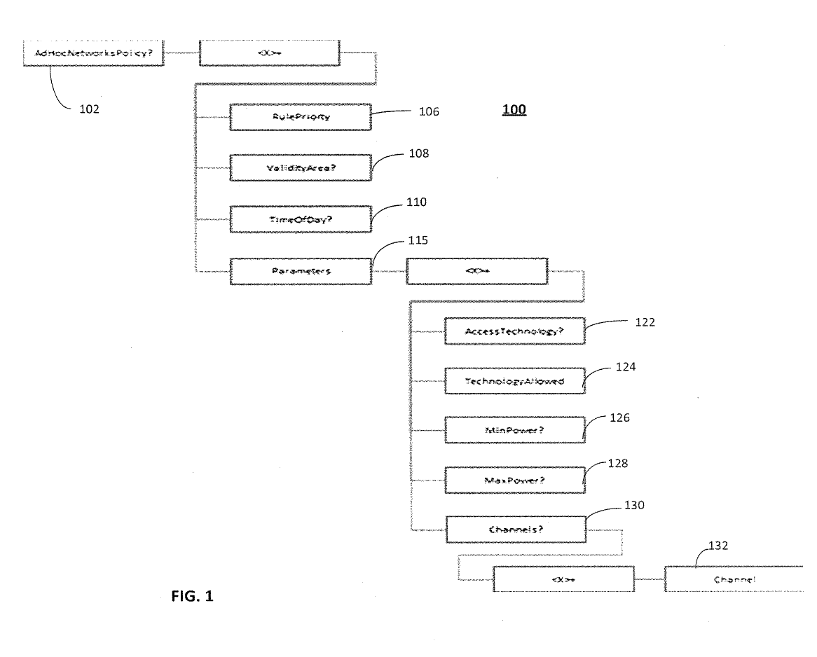

FIG. 1 depicts an example of information, such as a branch 100 that can be used to control non-infrastructure networks including non-infrastructure Wi-Fi networks, in accordance with some example embodiments. For example, a node in a network, such as an ANDSF server and the like, may send to a user equipment management objects including branch 100. When this is the case, the user equipment may evaluate the branch 100 in order to determine whether the user equipment is allowed to operate using non-infrastructure Wi-Fi (for example, Wi-Fi direct, Miracast, and/or the like). The branch 100 may also specify how and/or when the user equipment can operate using non-infrastructure Wi-Fi.

Although some of the examples described herein refer to Wi-Fi, Miracast, Wi-Fi direct, and ANDSF, these are examples as other radio technologies and standards may be used as well including Bluetooth, Bluetooth Low Energy, and/or the like.

The branch 100 may be configured as a policy/rules branch in accordance with an ANDSF management object, although the policy branch (labeled “AdHocNetworksPolicy” 102) may be configured in accordance with other standards as well.

The AdHocNetworksPolicy branch 100 may be an optional branch in a given management object, but if the AdHocNetworksPolicy branch 100 is present or activated, there may be one or more rules therein.

In the example of FIG. 1, the AdHocNetworksPolicy branch 100 may include an information element for RulePriority 106, in accordance with some example embodiments. RulePriority 106 defines a priority for a rule provided by the AdHocNetworksPolicy 106. For example, if more than one rule exists (in branch 100 or other portions of the management object), the priority may define which rule(s) to execute or a sequence for the rules based on priority of execution.

In some example embodiments, the AdHocNetworksPolicy branch 100 may include an information element for a ValidityArea 108. ValidityArea 108 may define an area, such as a coverage area, where a rule provided by the AdHocNetworksPolicy branch 100 is enforced. The area may define a cell identifier (ID), geographic area, and/or the like, in which the rules is to be enforced (or is valid). For example, a rule may be specified for a given cell or group of cells.

In some example embodiments, the AdHocNetworksPolicy branch 100 may include an information element for a TimeOfDay 110. TimeOfDay 110 may define a time when a rule provided by the AdHocNetworksPolicy branch 100 is enforced. For example, time of day may restrict the non-infrastructure Wi-Fi to one or more given time periods (for example, between 10 AM-2 PM or 8 PM and 11 PM).

In some example embodiments, the AdHocNetworksPolicy branch 100 may include one or more parameters 115 related to the non-infrastructure network. Parameters 115 may include one or more of the following parameters in accordance with some example embodiments: AccessTechnolgy 122, TechnologyAllowed 124, MinPower 126, MaxPower 128, Channels 130, Channel 132, and/or the like.

In some example embodiments, parameters 115 may define (and thus control at the user equipment) the specific types of radio access technology 122 (for example, such as Wi-Fi Direct, Miracast, or IBSS) and whether the access technology 122 is allowed 124 for use at the user equipment. For example, access technology 122 may specify that Wi-Fi direct, and TechnologyAllowed 124 may indicate whether Wi-Fi direct is allowed (for example, yes allowed or, alternatively, no inhibited) at a user equipment.

Parameters 115 may also define, in accordance with some example embodiments, power levels at 126 and 128 for the access technology 122. For example, MinPower 126 and MaxPower 128 may define (and thus control at the user equipment) the minimum and maximum transmit power for the allowed access technology 122.

Parameters 115 may also define, in accordance with some example embodiments, which radio channels 130 can be used for the access technology 122. For example, the radio channels 130 may list one or more specific channels at 132 and the like to be used by a user equipment when operating with the access technology 122 allowed at 124.

Before further describing branch 100, a description is provided below with respect to an example of a system 200 in which the branch 100 may be implemented.

In some example embodiments, system 200 may include a core network 290 coupled via one or more backhaul links/networks to a plurality of base stations, such as base stations 210A-B serving cells 212A-B. System 200 may also include one or more small cells, such as a small cell 212C served by WLAN access point 210C. WLAN access point 210C may also have one or more backhaul links/networks to the core network 290 and the like. System 200 may also include one or more user equipment 214A-C.

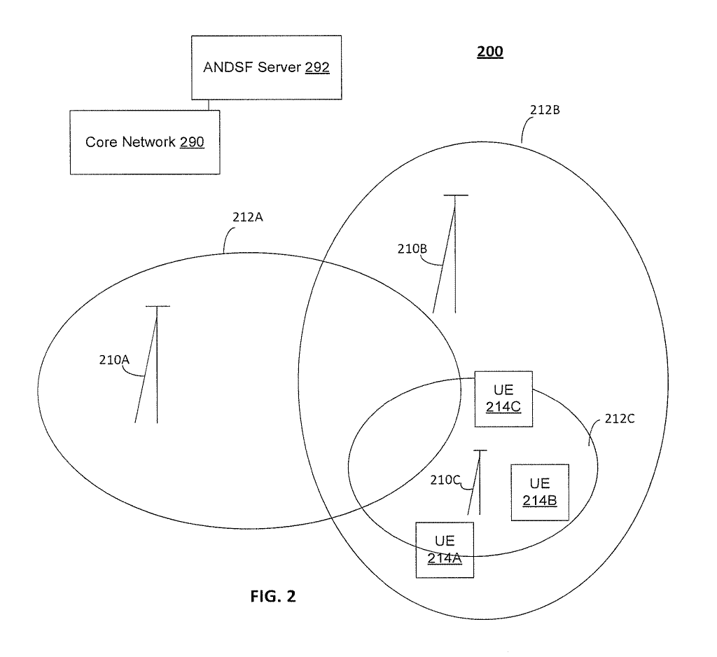

Although FIG. 2 depicts a certain quantity and configuration of devices, other quantities and configurations may be implemented as well. For example, other quantities and configurations of base stations/access points, cells, and user equipment may be implemented as well.

The network may include a cellular radio access network (RAN) and a core network 290. The RAN may consist of at least cellular base stations 210A-B that serve cells 212A-B. The core network 290 may include links to other nodes, such as an access network discovery and selection function (ANDSF) server 292 and the like.

In some example embodiments, ANDSF server 292 may provide ANDSF policy for a user equipment to enable control (for example, via branch 100 at FIG. 1) of certain types of WLAN technology including whether, how, and when the WLAN technology including non-infrastructure Wi-Fi are allowed to be used within a small cell, such as infrastructure WLAN 212C. ANDSF server 292 may also provide network selection policy as well (for example, WLAN for offloading and/or on-loading back to the cellular RAN, such as base station 210A-B). The network may signal (via a base station or wireless access point) a user equipment, and this signaling may include information elements configured as for example ANDSF management objects (although the information elements may be configured in accordance with other standards as well including Hot Spot 2.0 and/or the like). Moreover, this signaling may, in some example embodiments, trigger the user equipment to evaluate or re-evaluate one or more ANDSF policies including branch 100 relating to the WLAN technology including non-infrastructure Wi-Fi (for example, whether the non-infrastructure Wi-Fi can be used within a small cell or a macrocell, how the non-infrastructure Wi-Fi can be used, when the non-infrastructure Wi-Fi can be used, and/or whether non-infrastructure Wi-Fi are allowed to be used within a cell, such as small cell 212C).

In some example embodiments, a user equipment, such as user equipment 214A-C, may be implemented as a mobile device and/or a stationary device. The user equipment may be referred to as, for example, a wireless device, a mobile station, a mobile unit, a subscriber station, a wireless terminal, a tablet, a smart phone, and/or the like. In some example embodiments, user equipment may be implemented as multi-mode user devices configured to operate using a plurality of radio access technologies, although a single-mode device may be used as well. For example, the user equipment may be configured to operate using a plurality of radio access technologies including one or more of the following: Long Term Evolution (LTE), wireless local area network (WLAN) technology, such as 802.11 Wi-Fi and the like, Wi-Fi Direct, Miracast, Wi-Fi screencasting, Miracast, Bluetooth, Bluetooth low energy (BT-LE), near field communications (NFC), and any other radio access technologies. The user equipment may be located within the coverage area of a cell or multiple cells.

The base stations 210A-B may, in some example embodiments, be configured as an evolved Node B (eNB) type base station, although other types of base stations and wireless access points may be used as well. In the case of eNB type base station, the base station may be configured in accordance with standards, including the Long Term Evolution (LTE) standards, such as 3GPP TS 36.201, Evolved Universal Terrestrial Radio Access (E-UTRA); Long Term Evolution (LTE) physical layer; General description, 3GPP TS 36.211, Evolved Universal Terrestrial Radio Access (E-UTRA); Physical channels and modulation, 3GPP TS 36.212, Evolved Universal Terrestrial Radio Access (E-UTRA); Multiplexing and channel coding, 3GPP TS 36.213, Evolved Universal Terrestrial Radio Access (E-UTRA); Physical layer procedures, 3GPP TS 36.214, Evolved Universal Terrestrial Radio Access (E-UTRA); Physical layer—Measurements, and any subsequent additions or revisions to these and other 3GPP series of standards (collectively referred to as LTE standards). The base stations may also be configured to serve, as part of the infrastructure, cells using a WLAN technology, such as Wi-Fi (for example, the IEEE 802.11 series of standards), as well as any other radio access technology capable of serving a cell. In the example of FIG. 2, base station/access point 210C may be configured to serve small cell 212C using Wi-Fi, although any other radio access technology may be used as well. The base stations may have wired and/or wireless backhaul links to other networks and/or network nodes including core network 290.

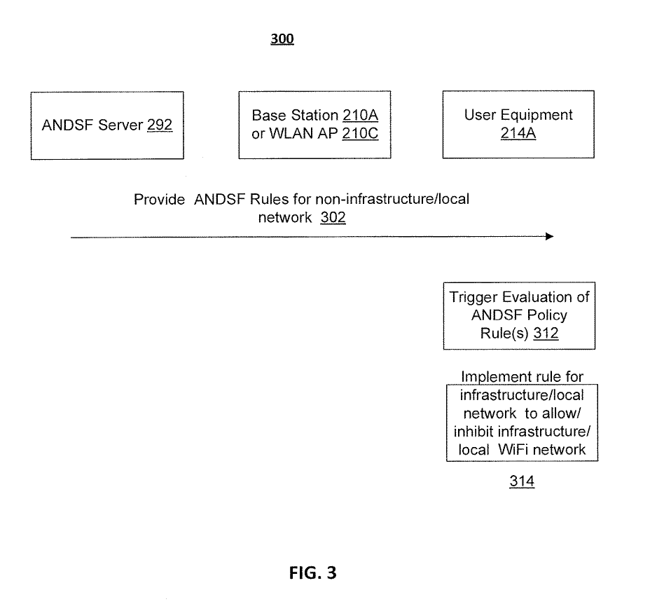

FIG. 3 depicts an example process 300 for non-infrastructure network control, in accordance with some example embodiments. The description of process 200 also refers to FIGS. 1 and 2.

At 302, a network node, such as ANDSF server 292, may provide one or more sets of ANDSF policies to a user equipment, such as user equipment 214A, in accordance with some example embodiments. The ANDSF policies may include information elements including branch 100 related to a local service network, such as a non-infrastructure network control. The ANDSF policies including branch 100 may be provided via a base station 210B and/or WLAN access point 210C to user equipment 214A. Moreover, the ANDSF policies may be carried by RAN signaling, a broadcast, and/or provided in other ways as well.

In some example embodiments, an event may trigger, at 312, the user equipment 214A to evaluate ANDSF policies including branch 100, in accordance with some example embodiments. For example, the network may signal UE 214A to evaluate ANDSF policies including branch 100. Alternatively or additionally, an event, such as the user equipment 214A's need to establish an non-infrastructure Wi-Fi network with for example user equipment 214B may trigger evaluation of ANDSF policies including branch 100. When this is the case, user equipment 214A may evaluate the ANDSF policy including branch 100 and determine whether, how, and when to use the non-infrastructure network, without requiring the network to trigger the evaluation.

At 314, the triggered ANDSF policies including branch 100 may be evaluated, in accordance with some example embodiments. For example, the ANDSF policy/rule sent at 302 may include one or more of the following: a validity area 108 defining at least a region including for example cell coverage area 212C, a time of day 110 (for example, any time of day), and/or parameters 115 including Wi-Fi Direct as the access technology 122 and that Wi-Fi Direct is allowed 124. The parameters may also specify the power 126-128 and/or channels 130 as noted above. In this example, when user equipment 214A evaluates, at 312, the ANDSF policy, the user equipment 214A may implement, at 314, the ANDSF policy by allowing non-infrastructure Wi-Fi Direct connection to another device, such as user equipment 214B. On the other hand, if Wi-Fi Direct 122 is inhibited (for example, not allowed at 124) the user equipment 214A may implement, at 314, the ANDSF policy by inhibiting the non-infrastructure Wi-Fi direct connection to other devices. The process 300 may thus enable a service provider or network to control the use of non-infrastructure networks.

Although the previous example described non-infrastructure network control within a small cell, the control of non-infrastructure networks may be within a macro cell, such as cell 212A.

Moreover, although the previous example referred to non-infrastructure network control using ANDSF management object, the control may be in accordance with other mechanisms including HotSpot 2.0, as well as other management objects from 3GPP specifications and/or Wi-Fi Alliance.

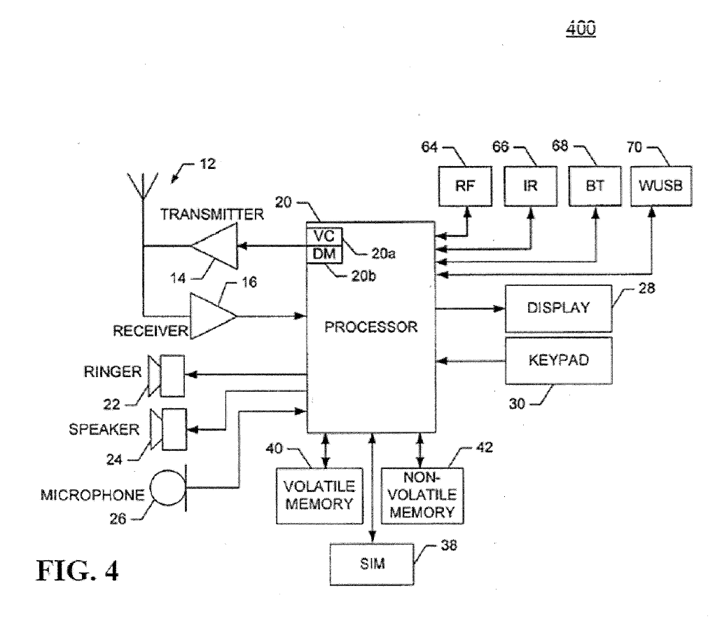

FIG. 4 depicts an example of an apparatus 400, in accordance with some example embodiments. The apparatus 400 may comprise a user equipment, such as a smart phone, a cell phone, a wearable radio device, and/or any other radio based device including for example a wireless access point/base station.

In some example embodiments, apparatus 400 may also include a radio communication link to a cellular network, or other wireless network. The apparatus 400 may include at least one antenna 12 in communication with a transmitter 14 and a receiver 16. Alternatively transmit and receive antennas may be separate.

The apparatus 400 may also include a processor 20 configured to provide signals to and from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 130 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Apparatus 400 may include a location processor and/or an interface to obtain location information, such as positioning and/or navigation information. Accordingly, although illustrated in as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as, Institute of Electrical and Electronics Engineers (IEEE) 802.11, 802.16, and/or the like. In addition, these signals may include speech data, user generated data, user requested data, and/or the like.

The apparatus 400 may be capable of operating with one or more air interface standards, communication protocols, modulation types, access types, and/or the like. For example, the apparatus 400 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 400 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 400 may be capable of operating in accordance with 2.5G wireless communication protocols General Packet Radio Service (GPRS), Enhanced Data GSM Environment (EDGE), and/or the like. Further, for example, the apparatus 400 may be capable of operating in accordance with 3G wireless communication protocols, such as, Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 130 may be additionally capable of operating in accordance with 3.9G wireless communication protocols, such as, Long Term Evolution (LTE), Evolved Universal Terrestrial Radio Access Network (E-UTRAN), and/or the like. Additionally, for example, the apparatus 400 may be capable of operating in accordance with 4G wireless communication protocols, such as LTE Advanced and/or the like as well as similar wireless communication protocols that may be subsequently developed.

It is understood that the processor 20 may include circuitry for implementing audio/video and logic functions of apparatus 400. For example, the processor 20 may comprise a digital signal processor device, a microprocessor device, an analog-to-digital converter, a digital-to-analog converter, and/or the like. Control and signal processing functions of the apparatus 400 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 400 to perform actions. For example, processor 20 may be capable of operating a connectivity program, such as, a web browser. The connectivity program may allow the apparatus 400 to transmit and receive web content, such as location-based content, according to a protocol, such as, wireless application protocol, wireless access point, hypertext transfer protocol, HTTP, and/or the like.

Apparatus 400 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 400 may include a battery for powering various circuits related to the mobile terminal, for example, a circuit to provide mechanical vibration as a detectable output. The user input interface may comprise devices allowing the apparatus 400 to receive data, such as, a keypad 30 (which can be a virtual keyboard presented on display 28 or an externally coupled keyboard) and/or other input devices.

Moreover, the apparatus 400 may include a short-range radio frequency (RF) transceiver and/or interrogator 64, so data may be shared with and/or obtained from electronic devices in accordance with RF techniques. The apparatus 400 may include other short-range transceivers, such as an infrared (IR) transceiver 66, a Bluetooth (BT) transceiver 68 operating using Bluetooth wireless technology, a wireless universal serial bus (USB) transceiver 70, and/or the like. The Bluetooth transceiver 68 may be capable of operating according to low power or ultra-low power Bluetooth technology, for example, Wibree, Bluetooth Low-Energy, and other radio standards. In this regard, the apparatus 400 and, in particular, the short-range transceiver may be capable of transmitting data to and/or receiving data from electronic devices within proximity of the apparatus, such as within 10 meters. The apparatus 400 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 400 may comprise memory, such as, a subscriber identity module (SIM) 38, a removable user identity module (R-UIM), and/or the like, which may store information elements related to a mobile subscriber. In addition to the SIM, the apparatus 400 may include other removable and/or fixed memory. The apparatus 400 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations as described herein at for example process 300. The memories may comprise an identifier, such as an international mobile equipment identification (IMEI) code, capable of uniquely identifying apparatus 400. The memories may also store the management objects, such as branch 100. The functions may include one or more of the operations disclosed herein including the process flow at FIG. 3 for example. The memories may comprise an identifier, such as an international mobile equipment identification (IMEI) code, capable of uniquely identifying apparatus 400. In the example embodiment, the processor 20 may be configured using computer code stored at memory 40 and/or 42 to provide the operations, such as generate a management object (for example, one or more of the information elements at branch 100), store the generated management object, receiving one or more network selection policies (for example, management objects including branch 100), triggering the evaluation of the management object, allowing, at the user equipment to access or establish an non-infrastructure network, when the received network selection policy indicate the non-infrastructure network is allowed in for example a given area/region, and/or inhibiting, at the user equipment to access or establish an non-infrastructure network, when the received network selection policy indicate the non-infrastructure network is not allowed in for example a given area/region.

Some of the embodiments disclosed herein may be implemented in software, hardware, application logic, or a combination of software, hardware, and application logic. The software, application logic, and/or hardware may reside in memory 40, the control apparatus 20, or electronic components disclosed herein, for example. In some example embodiments, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry. A computer-readable medium may comprise a non-transitory computer-readable storage medium that may be any media that can contain or store the instructions for use by or in connection with an instruction execution system, apparatus, or device, such as a computer. Furthermore, some of the embodiments disclosed herein include computer programs configured to cause methods as disclosed herein (see, for example, the process 300 and the like).

Without in any way limiting the scope, interpretation, or application of the claims appearing below, a technical effect of one or more of the example embodiments disclosed herein is enhanced control of non-infrastructure networks. Moreover, the control may be compatible with ANDSF.

The subject matter described herein may be embodied in systems, apparatus, methods, and/or articles depending on the desired configuration. For example, the systems, apparatus, methods, and/or articles described herein can be implemented using one or more of the following: electronic components such as transistors, inductors, capacitors, resistors, and the like, a processor executing program code, an application-specific integrated circuit (ASIC), a digital signal processor (DSP), an embedded processor, a field programmable gate array (FPGA), and/or combinations thereof. These various example embodiments may include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the example embodiments described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

1-23. (canceled)

24. A method comprising:
receiving, at a user equipment, a network selection policy, wherein the network selection policy indicates whether the user equipment is allowed to or inhibited from operating in accordance with a local service network;
allowing, at the user equipment when the received network selection policy indicates an allowance, transmission via the local service network; and
inhibiting, at the user equipment when the received network selection policy indicates an inhibition, transmission via the local service network.

25. The method of claim 24, wherein the network selection policy is received from at least one of a cellular network or a wireless local area network controller.

26. The method of claim 24 further comprising:
evaluating the network selection policy to determine whether transmission via the local service network is allowed to operate within a coverage area defined by the network selection policy.

27. The method of claim 26 or an event at the user equipment.

28. The method of claim 24, wherein the network selection policy comprises at least one access network discovery and selection function policy.

29. The method of claim 28, wherein the at least one access network discovery and selection function policy is sent by an access network discovery and selection function server as an access network discovery and selection function management object including information to control the local service network.

30. The method of claim 24, wherein the network selection policy comprises at least one of a rule priority representative of a priority for a rule contained within the network selection policy, a validity area indicating an area over which the rule is to be enforced, a time of day indicating a time when the rule is to be enforced, and one or more parameters.

31. The method of claim 30, wherein the one or more parameters define at least one of a type of access technology, an indication of whether the type of access technology is allowed, transmit power information, or channel information.

32. The method of claim 24, wherein the local service network comprises a non-infrastructure wireless local area network providing at least one of a service or application among a plurality of user equipment coupled via the local service network.

33. An apparatus, comprising:
at least one processor; and
at least one memory including computer program code, the at least one memory and the computer program code configured to, with the at least one processor, cause the apparatus to perform at least the following:
receive, at the apparatus, a network selection policy, wherein the network selection policy indicates whether the apparatus is allowed to or inhibited from operating in accordance with a local service network;
allow, at the apparatus when the received network selection policy indicates an allowance, transmission via the local service network; and
inhibit, at the apparatus when the received network selection policy indicates an inhibition, transmission via the local service network.

34. The apparatus of claim 33, wherein the network selection policy is received from at least one of a cellular network or a wireless local area network controller.

35. The apparatus of claim 33, wherein the apparatus is further configured to at least evaluate the network selection policy to determine whether transmission via the local service network is allowed to operate within a coverage area defined by the network selection policy.

36. The apparatus of claim 33, wherein the apparatus is further configured to at least evaluation is triggered by at least one of signaling received from a network node or an event at the apparatus.

37. The apparatus of claim 33, wherein the network selection policy comprises at least one access network discovery and selection function policy.

38. The apparatus of claim 37, wherein the at least one access network discovery and selection function policy is sent by an access network discovery and selection function server as an access network discovery and selection function management object including information to control the local service network.

39. The apparatus of claim 33, wherein the network selection policy comprises at least one of a rule priority representative of a priority for a rule contained within the network selection policy, a validity area indicating an area over which the rule is to be enforced, a time of day indicating a time when the rule is to be enforced, and one or more parameters.

40. The apparatus of claim 39, wherein the one or more parameters define at least one of a type of access technology, an indication of whether the type of access technology is allowed, transmit power information, or channel information.

41. The apparatus of claim 33, wherein the local service network comprises a non-infrastructure wireless local area network providing at least one of a service or application among a plurality of apparatus coupled via the local service network.

42. The apparatus of claim 33, wherein the local service network comprises at least one of a Wi-Fi direct, Wi-Fi screencasting, an independent basic service set, or miracast.

43. The apparatus of claim 33, wherein the apparatus comprises a user equipment.
